(19) United States
(12) Patent Application Publication
(10) Pub. No.: US 2018/0243982 A1
(43) Pub. Date: Aug. 30, 2018

(54) Systems and methods for additive manufacturing of hybrid multi-material constructs and constructs made therefrom

(71) Applicant: The Board of Trustees of the Leland Stanford Junior University, Palo Alto, CA (US)

(72) Inventors: Yaser Shanjani, Milpitas, CA (US); Yunzhi Yang, Redwood City, CA (US); Chi-Chun Pan, Stanfrod, CA (US)

(21) Appl. No.: 15/756,827

(22) PCT Filed: Aug. 24, 2016
(86) PCT No.: PCT/US16/48468

§ 371 Date: Mar. 1, 2018

Related U.S. Application Data
(60) Provisional application No. 62/212,988, filed on Sep. 1, 2015.

(51) Int. Cl. B29C 64/20; B33Y 30/00; B33Y 70/00; B29C 64/118; B29C 64/135; B29C 64/393; B33Y 50/02

(52) U.S. Cl. CPC B29C 64/20; B33Y 30/00; B33Y 70/00; B29C 64/118; B29K 2101/10; B29C 64/393; B33Y 50/02; B29K 2995/0005; B29C 64/135

(57) ABSTRACT

A simultaneous thermoplastic and thermoset deposition system is provided that includes a substrate holder, a thermoplastic molten-material extruder, photo-polymerizing light source, a prepolymer vat, and a controller, where the controller controls the thermoplastic extruder to deposit a thermoplastic layer according to a thermoplastic pattern on the substrate holder, where the controller controls the substrate holder to immerse the thermoplastic layer in the prepolymer vat for coating the thermoplastic layer with a coating of the prepolymer solution, where the controller controls the substrate holder to position the prepolymer coated thermoplastic layer for exposure to the photo-polymerizing light source, where the controller controls the photo-polymerizing light source to cure the prepolymer coating according to a thermoset pattern on the thermoplastic layer, where the controller iteratively controls the substrate holder, the thermoplastic molten-material extruder, and the photo-polymerizing light source to form a thermoset structure that is integrated to a thermoplastic structure.

### FIELD OF THE INVENTION

This invention relates to functional thermoplastic and thermoset deposition system for a variety of applications.

### BACKGROUND OF THE INVENTION

Three dimensional (3D) bioprinting technology holds great promise in forming tissue engineering constructs (TECs) in vitro and aiding tissue regeneration in vivo. Also, 3D bioprinted TECs provide a practical means for studying cell behavior in 3D physiologically relevant conditions and drug discovery such as cancer cell behavior under therapy compared to traditional 2D culture. In general, 3D bioprinting forms TECs via precise layer-by-layer positioning of biomaterials, biological agents, and/or living cells. Various technologies and methods have been developed and utilized in an attempt to fabricate such complex constructs including material extrusion and deposition, stereolithography, inkjet printing, syringe-dispensing and direct writing, two photon polymerization, laser-assisted cell printing. etc. Each of these technologies provides advantages and disadvantages in terms of material range, accuracy, resolution, and speed. Most of these methods are capable to form only one type of biomaterial, mostly soft hydrogels as cell and drug carrier or rigid biopolymers, ceramics, and composite as biodegradable tissue scaffolds. For example, poly-(ε-caprolactone) (PCL), poly-lactide acid (PLA), calcium phosphates and composites of them are widely utilized for 3D rigid porous scaffolds whereas poly-ethylene glycol (PEG)-based material, alginate, and hyaluronic acid have been bioprinted as cell-laden hydrogels TECs. However, mimicry of natural tissues requires engineered complex constructs to be composed of both (1) rigid porous biomaterial scaffolds for structural and mechanical integrity, and (2) soft hydrogels for carrying bioagents such as biochemical cues or cells, providing appropriate microenvironment for cellular functions, including adhesion, migration, proliferation, and differentiation, More recently, with the advance of novel extracellular matrix-like biomaterials, 3D bioprinting technology is gaining momentum to realize such multi-material constructs for tissue engineering and pharmaceutical industry. What is needed is a 3D bioprinting system that integrates soft and rigid multifunctional components.

### SUMMARY OF THE INVENTION

To address the needs in the art, a simultaneous thermoplastic and thermoset deposition system is provided that includes a substrate holder, a thermoplastic molten-material extruder, photo-polymerizing light source, a prepolymer vat, and a controller, where the controller controls the thermoplastic extruder to deposit a thermoplastic layer according to a thermoplastic pattern on the substrate holder, where the controller controls the substrate holder to immerse the thermoplastic layer in the prepolymer vat for coating the thermoplastic layer with a coating of the prepolymer solution, where the controller controls the substrate holder to position the prepolymer coated thermoplastic layer for exposure to the photo-polymerizing light source, where the controller controls the photo-polymerizing light source to cure the prepolymer coating according to a thermoset pattern on the thermoplastic layer, where the controller iteratively controls the substrate holder, the thermoplastic molten-material extruder, and the photo-polymerizing light source to form a thermoset structure that is integrated to a thermoplastic structure.

According to one aspect of the invention, the thermoplastic structure has a material that includes poly-(ε-caprolactone) (PCL), ABS, PLA, PLLA, PGA, PLGA, PEEK, PAEK, PEKK, polystyrene, TPU, TPE, HIPS, TPC, PVA, PA, PC, Wax, PP, PETT, PMMA, electrical conductive PLA, carbon fiber filled thermoplastics, magnetic nanoparticle filled thermoplastics, or ferromagnetic nanoparticle filled thermoplastics.

In another aspect of the invention, the thermoset structure has material that includes acrylate-based, diacrylate-based, methacrylate-based, epoxy-based, silicone-based, poly-ethylene glycol diacrylate (PEGDA)-based, hyaluronic acid-based, and chitosan-based.

The simultaneous thermoset and thermoplastic deposition system of claim 1, where the prepolymer vat includes living cells, growth factors, or pharmaceutical drugs such as antibacterials.

In another aspect of the invention, the photo-polymerizing light source is configured to project wavelengths in a range of UV to visible to crosslink the prepolymer coating according to the thermoset pattern. In one aspect, an exposure time of the photo-polymerizing light source is in a range of 0.5 second to 5 minutes.

In a further aspect of the invention, the thermoset structure has a single layer thickness in a range of 5-300 micrometers.

In one aspect of the invention, the thermoplastic structure has a single strut thickness in a range of 40-500 micrometers.

In yet another aspect of the invention, the thermoset component includes a conduit shape structure. In one aspect, the thermoplastic structure has a concentric shell around the thermoset conduit shape structure.

According to another aspect, the invention further includes an air-blowing mechanism configured to cool the extruded thermoplastic layer.

In another aspect, the invention includes a syringe-based deposition module (SDM) disposed to add a thermosensitive or chemically crosslinked hydrogel into pores of the thermoplastic, where the thermosensitive hydrogel includes collagen, where the chemically crosslinked hydrogel can include fibrinogen, collagen, alginate, or chitosan.

In another aspect of the invention, the thermoplastic or the thermoset includes an electrically conductive component, where the electrically conductive component includes connections, wires, or antennas, where the electrically conductive component is embedded within thermoset or thermoplastic structures.

### BRIEF DESCRIPTION OF THE DRAWINGS

FIGS. 1A-1B show the hybrid bioprinting system: (1A) schematic of the combinatory MME and DLP-SLA process with schematic of a hybrid scaffold-hydrogel construct during fabrication process, and (1B) flowchart of combinatory bioprinting process, where shown is the sequential deposition extruding of molten hard material and crosslinking of soft hydrogel via irradiation of visible light, according to one embodiment of the invention.

FIGS. 2A-2H show exemplary hybrid constructs composed of PEGDA hydrogel and PCL scaffold for variety of possible applications: (2A) Porous scaffold that the pores of which are filled with hydrogel, where this combination can be used for enhanced uniform 3D cell distribution across scaffold; (2B) Bulk hydrogel reinforced with PCL struts, where the struts embedded in the gel during layer-by-layer fabrication will improve mechanical properties of bulk gel; (2C) Biphasic construct composed of lower scaffold segment and upper PEGDA hydrogel, where the biphasic construct can be used as osteochondral plug for treatment of osteoarthritis; (2D) Porous PCL scaffold with spatially distributed hydrogel components across scaffold for local cell and drug delivery; (2E) Isometric view of a porous PCL scaffold with a PEGDA hydrogel conduit passing throughout which can be used as vascularized scaffold; (2F) Cross section of scaffold-conduit sample; (2G) Porous scaffold with a bifurcated solid-filled conduit, where the inlet/outlet of solid-filled conduit is shown from side view, and the cross section of the bifurcated solid-filled conduit is also shown, (2H) Porous scaffold with a bifurcated conduit, where the inlet/outlet of conduit is shown from side view, and the cross section of the bifurcated conduit is also shown according to embodiments of the current invention.

FIGS. 3A-3D show SEM microscopic pictures demonstrating integration of thermoset PEGDA hydrogel and thermoplastic PCL scaffold in hybrid constructs, (3A) and (3B) cross sections of freeze dried hybrid constructs where hydrogel component filled the space between scaffold struts and generated mechanical integrity with scaffold, where the dashed boxes in (3A) show the areas which are magnified in (3B); (3C) shows separation between gel and struts at their interface occurred via freeze drying process; (3D) shows the cross-section of freeze dried PEGDA, according to embodiments of the current invention.

FIGS. 4A-4B show cell encapsulation in bioprinted hybrid construct: (4A) Schematic of scaffold-hydrogel-cell design composed of PCL scaffold ring, HUVEC-laden PEGDA filling the hollow middle circle and C3H10T½ fibroblast-laden collagen filling the pores of scaffold; (4B) Quantified live cell percentage in the prepolymer solution after 5 and 12 hr in fabrication condition as well as in PEGDA hydrogel and scaffold-hydrogel hybrid construct upon and after 6 hr of fabrication. (*p<0.05), according to embodiments of the current invention.

FIGS. 5A-5B show the diffusion of culture media via the PEGDA conduit into cell-laden collagen: (5A) schematic of conduit-collagen-scaffold hybrid model, (5B) schematic of culture condition, according to embodiments of the current invention.

FIGS. 6-7 show of vascularized bone graft prototypes comprising an afferent artery, vascular manifold, capillary beds, efferent vein, and supportive scaffold for surgical anastomosis, according to embodiments of the current invention.

### DETAILED DESCRIPTION

The current invention provides a 3D bioprinting system that integrates soft and rigid multifunctional components for applications in tissue engineering and regenerative medicine, among others. In the hybrid constructs, the rigid porous scaffold provides mechanical support, structural integrity and 3D structural guidance for tissue development, while the hydrogel component acts as a diffusible component, such as a vascular conduit, or to deliver bioagents such as cells and growth factors to enhance the biological functionality of the construct. The innovated bioprinting process, technology and system provided herein forms such hybrid constructs and enables the inclusion of wide spectrum of material properties (from rigid polymers or composite materials to a very soft hydrogel), and with controlled spatial distribution of each individual material component and bioagents (cells, drugs and growth factors) across the hybrid construct.

In one example, the invention provides a system for the design and fabrication of a functional connectable and perfusable vascularized graft for tissue engineering and regenerative medicine applications. The innovated vascularized graft, for the first time, integrates a perfusable hydrogel conduit, a cell-laden hydrogel-based micro-environment, and rigid porous scaffold leading to sustained cell viability across the graft during in vitro culture and after in vivo implantation. This graft enables quick and easy connection of the inlet and outlet of its vasculature system/hydrogel conduit to culture media circulation tubes in vitro as well as host blood vessels in vivo resulting in prompt distribution of blood upon implantation. Surgical anastomosis is conducted via suture knot tying of the host vessels to the tapered solid shell of the hydrogel conduit ends. The graft is fabricated using a novel bioprinting technique and system that is potent to form customized grafts with complex geometries and varying configuration of vascular hydrogel conduits. Functionality of a hybrid construct composed of porous scaffold with an embedded hydrogel conduit has been characterized demonstrating high material diffusion and high cell viability in about 2.5 mm distance surrounding the conduit indicated that culture media effectively diffused through the conduit and fed the cells. The results suggest that the developed technology is potent to form functional tissue engineering constructs composed of rigid and soft biomaterials.

In general, this invention comprises a novel 3D hybrid bioprinting technology (Hybprinter) offering capability to enable integration of soft and rigid components. Hybprinter employs photo-polymerization and molten material extrusion (MME) techniques for soft and rigid materials, respectively. For photopolymerization of thermoset prepolymer solution, digital light processing based stereolithography (DLP-SLA) can be used. For instance, poly-ethylene glycol diacrylate (PEGDA) and poly-(ε-caprolactone) (PCL) have been used as a model material for soft hydrogel and rigid scaffold, respectively.

The geometrical accuracy, swelling ratio and mechanical properties of the hydrogel component can be tailored by the photocrosslinking mechanism such as DLP-SLA module. The printability of variety of complex hybrid construct designs have been demonstrated using the Hybprinter technology and characterized the mechanical properties and functionality of such constructs. The compressive mechanical stiffness of a hybrid construct (90% hydrogel) is significantly higher than hydrogel itself (˜6 MPa vs. 100 kPa). In addition, viability of cells incorporated within the bioprinted hybrid constructs is approximately 90%. In addition, the interface condition of thermoset and thermoplastic component of hybrid constructs can be tailored by photocrosslinking conditions that can be controlled by the photocrosslinking light source. For instance, the intensity and energy dosage at the interface of prepolymer and thermoplastic struts can be controlled by the photocrosslinking mechanism such as DLP system and control software to enhance the physical and mechanical interlock or chemical bond between crosslinked polymer and solidified thermoplastic material.

Hybprinter utilizes MME module to form rigid scaffold via feeding a filament of material into a high temperature nozzle to melt, extrude and deposit as tiny struts. Through controlling the filament feeding rate and nozzle moving speed the diameter of the scaffold struts can be tailored with high reproducibility.

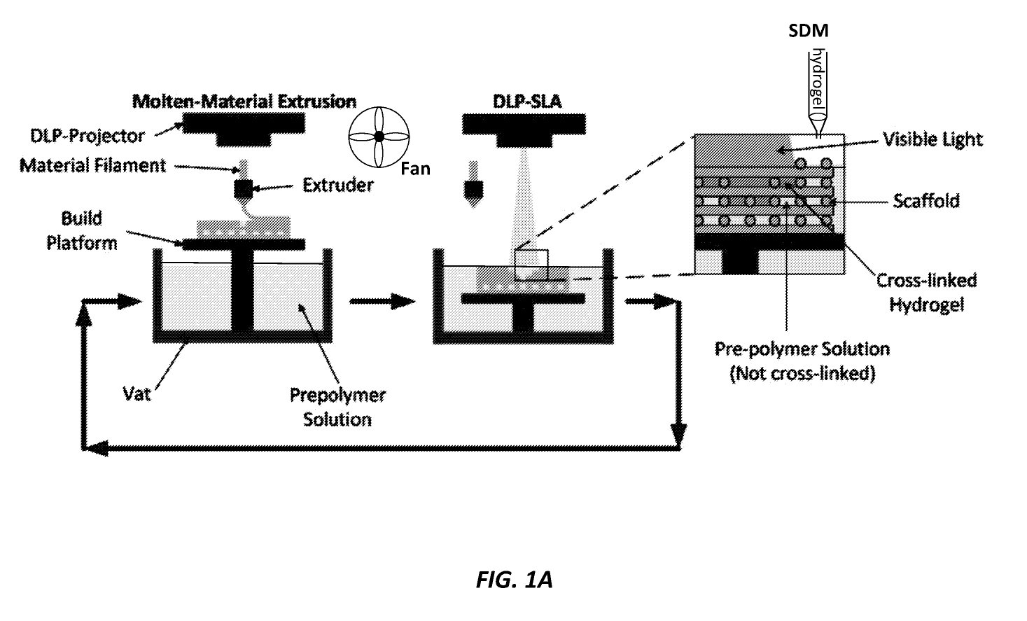

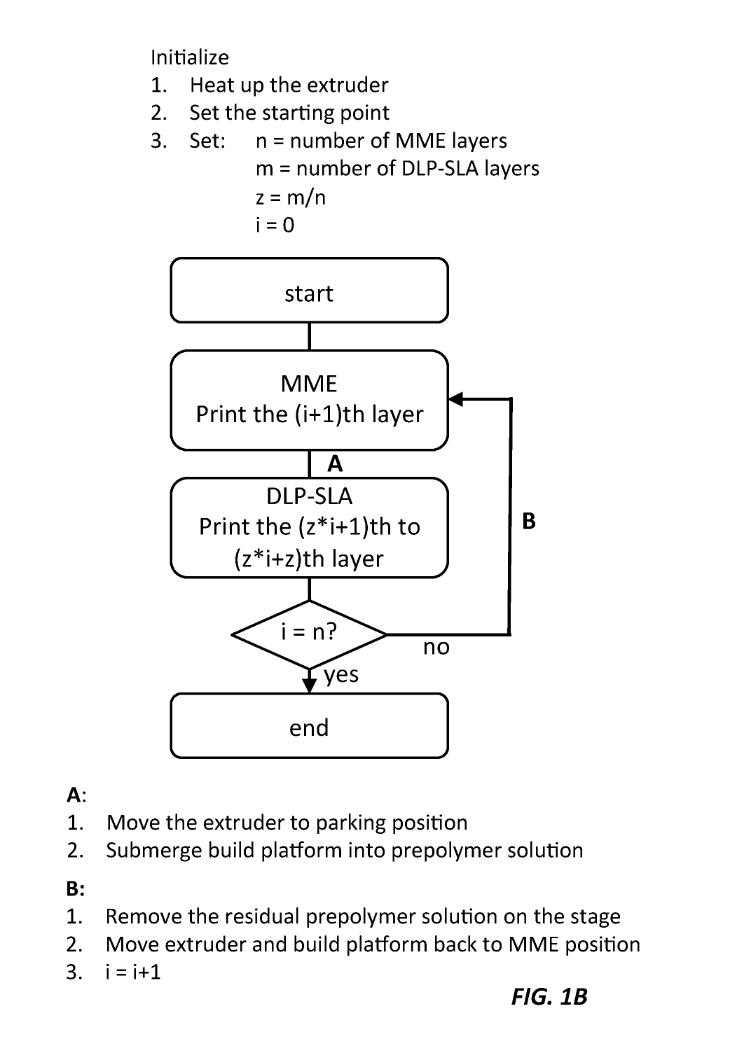

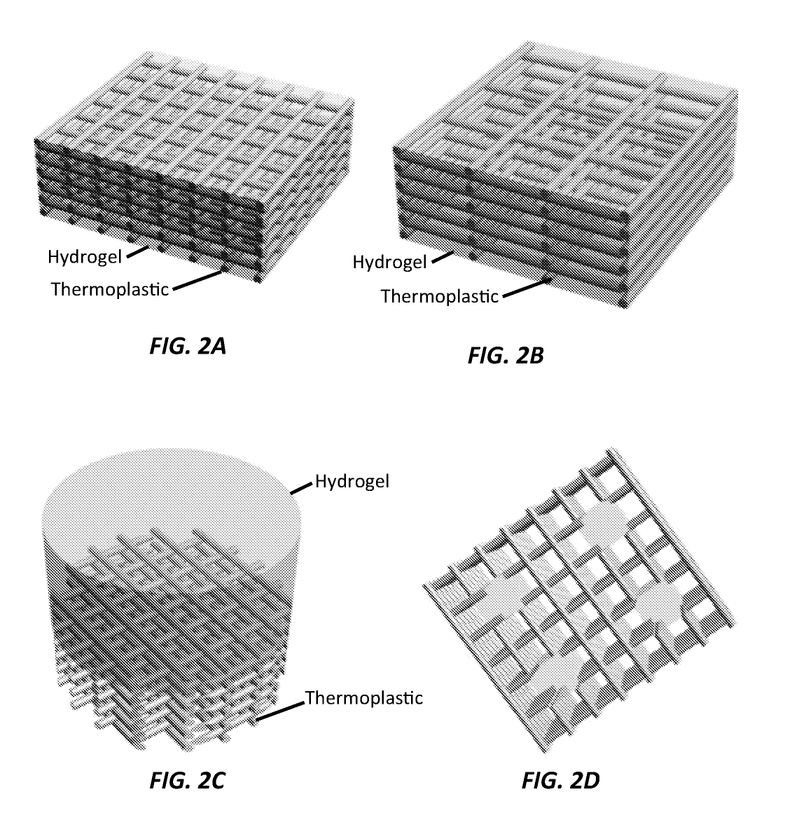

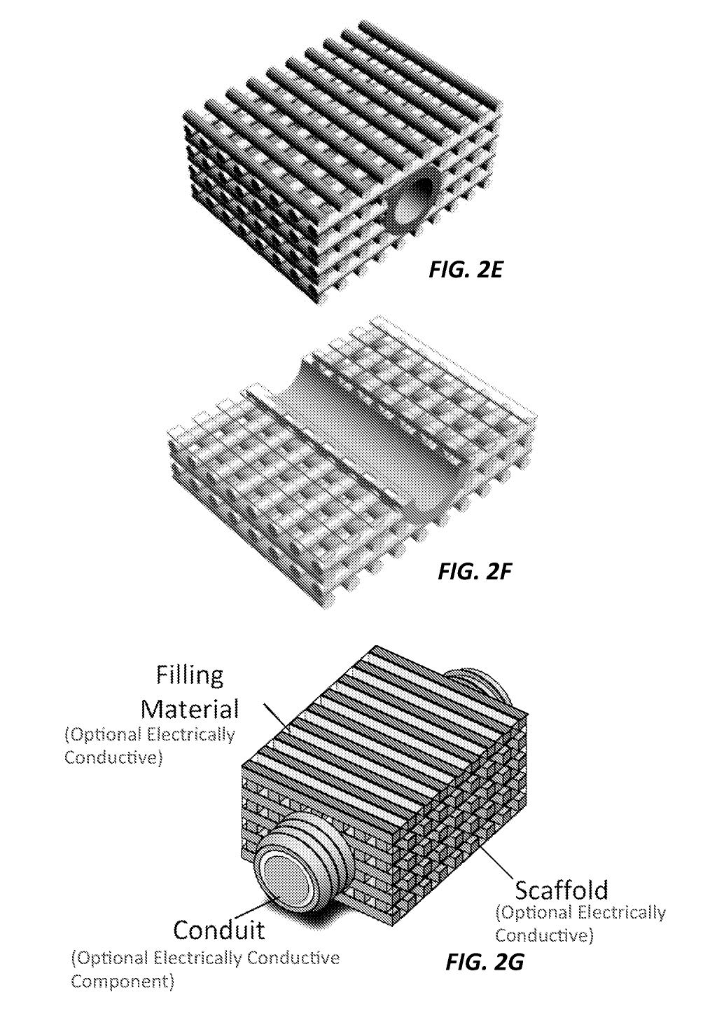

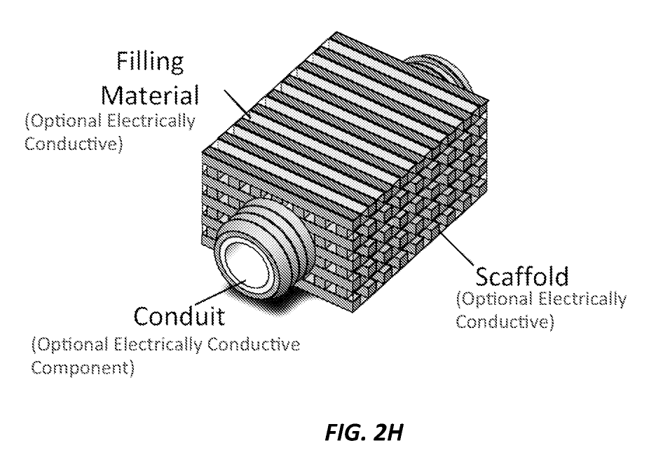

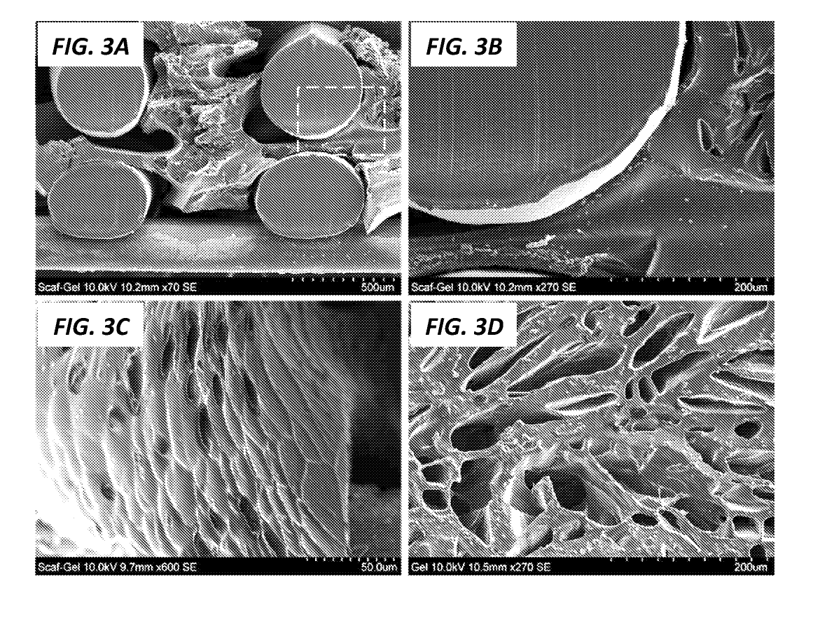

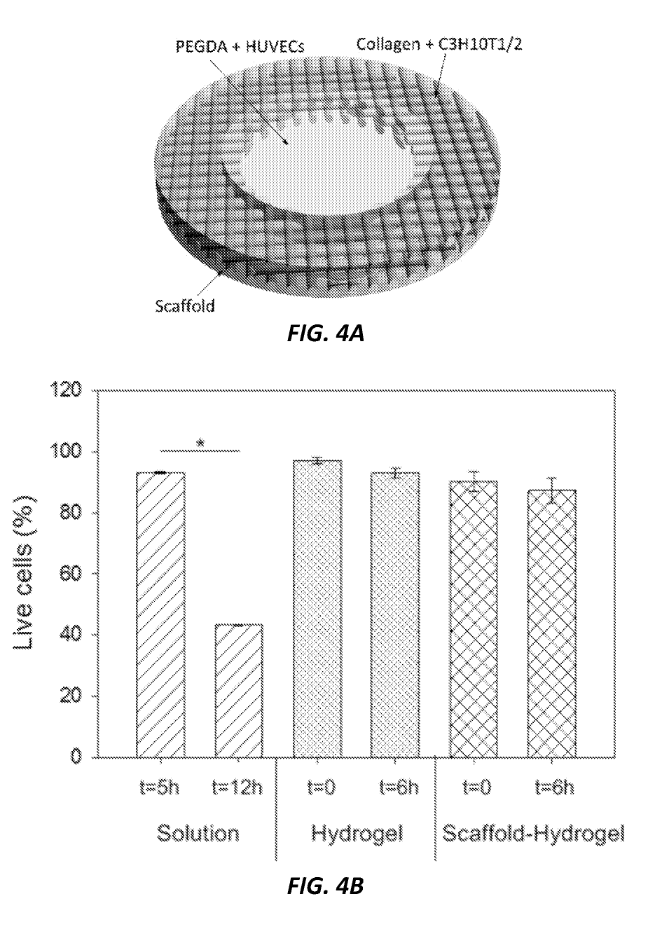

According to one embodiment, to form a hydrogel component of hybrid constructs, the Hybprinter utilizes the photocrosslinking mechanism such as DLP-based SLA technique that projects the visible light on the solution to gel the prepolymer to the shape of each target layer. This technique provides high resolution and high accuracy hydrogel components with small layer thickness (˜35 μm) depending on exposure time. Also, because visible light is used and the exposure duration is relatively short for each layer (in the range of 0.5 second to 5 seconds, or 0.5 second to 60 of seconds), the possibility of introducing damage to cells will be minimized compared with other UV-based techniques. To form hybrid constructs for different applications (see FIGS. 2A-2H), the Hybprinter employs MME and the photocrosslinking mechanism such as DLP-SLA modules in the required combinational sequence as shown in FIGS. 1A-1B. Unlike regular SLA processes, the support structure is not needed to form the hydrogel component of the hybrid constructs since the MME-made scaffold component acts as a support to build the hydrogel on (see FIGS. 2A-2H). The hydrogel component integrates well with the scaffold component and secures proper mechanical interlock with it as shown in FIGS. 3A-3B. In such combinatory systems, one important challenge is to adapt technologies/modules to deposit molten materials and crosslink hydrogel in a way that they do not inversely affect each other's function. It is demonstrated that the deposition of high temperature molten material does not affect previously formed hydrogel component. Also, the incorporated cells in the hydrogel component exhibited high viability except some of the cells located very close to the deposited scaffold struts (FIGS. 4A-4B).

Unlike regular SLA processes, the support structure is not needed to form the hydrogel component of the hybrid constructs since the MME-made scaffold component acts as a support to build the hydrogel on (see FIGS. 2A-2H).

According to one embodiment of the invention, since most of the synthetic polymers are hydrophobic, filling the pores of thermoplastic scaffold with hydrogel prepolymer solution during the formation of hybrid constructs might not happen properly. This issue has been reduced via immersing interconnected porous lattice scaffold component deep into the prepolymer solution before preparing the layers for crosslinking.

One of the major advantages of integrating soft hydrogel and rigid scaffold in a hybrid construct is to provide high mechanical properties proper for load bearing and a biological microenvironment suitable for cell growth and tissue development. Although the mechanical stiffness of the scaffold component is orders of magnitude higher than the hydrogel component, the stiffness of appropriately arranged hybrid scaffold-hydrogel of 90% hydrogel can be as high as that of scaffold component. This integration will overcome the limitations of the weak mechanical strength of conventional hydrogels, and significantly expand a broader spectrum of applications of hydrogels that are suitable for the physiologically relevant mechanical loading at daily life activity.

According to one example of the PCL and PEGDA with 18 sec exposure time, the interfacial mechanical integration between scaffold and hydrogel is in the range of ˜10 kPa before rupture happens. Although the interfacial shear strength obtained in this material combination and fabrication condition is lower than that of natural tissue (˜2-7 MPa) but can be improved by optimizing the design and material. In one embodiment, the fabrication process of the Hybprinter is capable of forming biphasic tissues such as osteochondral tissue.

A major advantage of bioprinting according to the current invention, compared to other conventional 3D cell seeding methods such as pipetting the cell solution onto porous scaffolds, is the control on the distribution of cells in 3D space. Hybprinter enables well-defined spatial distribution of cells in hybrid tissue engineering constructs with majority of cells (˜90%) surviving in the fabrication process and condition. The deposition of the molten PCL of layer #i do not introduce significant damage to the cells which were incorporated in the hydrogel layer #i−1.

Despite tremendous progress in the field of tissue engineering, vascularization has remained a strategic challenge that hampers the translation of most tissue engineering constructs to clinical practice. Another key feature of Hybprinter technology is to form TECs composed of porous scaffold with embedded hydrogel conduit as vascular graft. Hybprinter can readily form a hybrid construct comprised of a hydrogel-based conduit directly incorporated within a macro-porous scaffold and add a concentric rigid shell surrounding the conduit to enable a connection with a tube for perfusion of media for in vitro applications. This makes Hybprinter potent to form vascularized tissue engineering constructs.

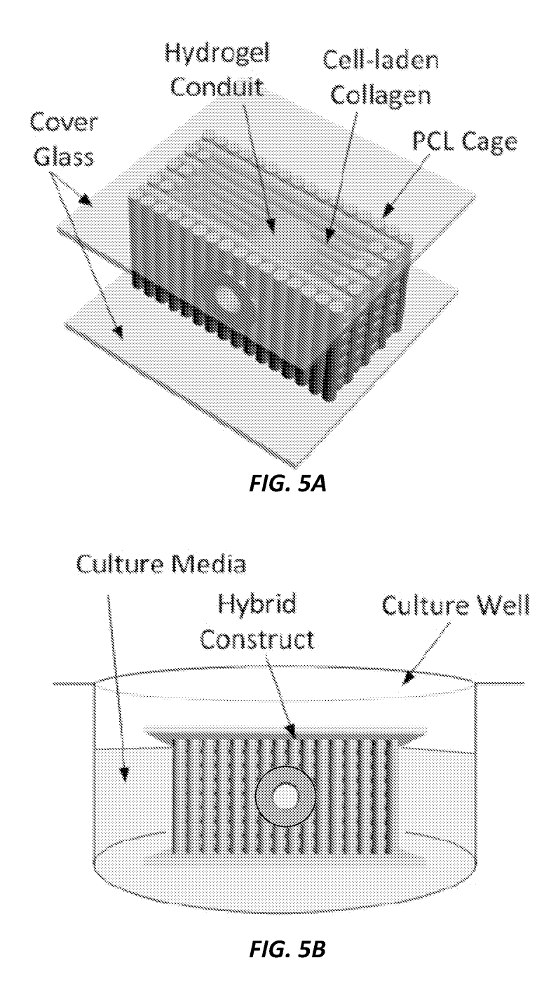

The rate of material diffusion throughout the hydrogel (PEGDA) conduit wall into a surrounding gel (such as collagen gel) across porous scaffold has been examined. In one example, a very slow flow 100 μl/min of food color solution in the conduit and no pressure was applied. The colored solution diffused and reached all the scaffold regions meaning about 5 mm distance from the conduit. It took about 10 hours to reach the saturation level. The results show that this hybrid model provides proper distribution of vital material supply to cells seeded across the scaffold for in vitro tissue engineering purposes. This functionality of such hybrid constructs was tested using a model that culture media can reach to the cells only via diffusion throughout an acellular conduit wall (see FIGS. 5A-5B). High cell viability after 5 days of culture is observed even in the regions with ˜2.5 mm distance from the conduit outer wall. This is an indicator of cells receiving enough nutrient and oxygen via diffusion of culture media through the hydrogel conduit wall and surrounding gel.

Other than in vitro studies, such scaffold-conduit hybrid construct can be utilized for improved engraftment in vivo. More specifically, the unique design of a rigid shell around a soft hydrogel conduit, that Hybprinter can create, enables surgical anastomosis with a major host vessel by direct connecting and suture knot tying to the rigid shell. This will allow for immediate blood perfusion upon implantation.

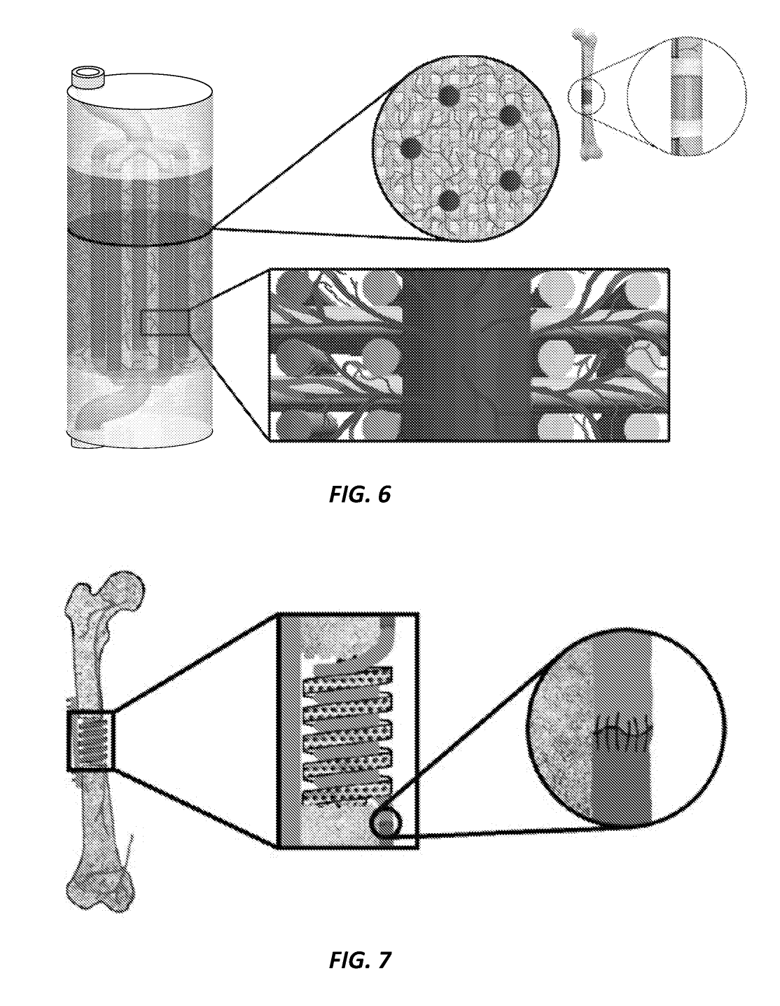

The current invention provides synthetic bone grafts that incorporate a conduit and enable immediate blood perfusion across a large construct. Some representative designs of vascularized bone graft prototypes for surgical anastomosis are shown in FIGS. 6-7. FIG. 6 shows a bioprinted large segmental bone graft comprising an afferent artery, capillary beds, efferent vein, and supportive scaffold. For such complex branched designs, the geometry of the conduit can be optimized to avoid turbulent flow since any disturbance in the blood flow may lead to blood stagnation and formation of intraluminal clots. Such perfusable vascular constructs have the potential to facilitate vascularization in vitro and engraftment in vivo as we showed previously that a central endothelialized lumen in a collagen infiltrated ceramic construct promoted angiogenesis in vitro and in vivo. These abovementioned features are not readily feasible in single-piece constructs via conventional bioprinting techniques. Furthermore, FIG. 7 shows schematic of another prototype of large vascularized bone graft comprising a 3D printed scaffold of a helical groove configuration, a 3D printed shell and a vessel graft. The latter can be fabricated by either bioprinting or other technologies such as native vessel graft, decellularized vessel graft, or synthetic vessel graft like hollow fiber membrane.

The current invention forms hybrid constructs composed of rigid porous scaffold and soft components using its MME and photocrosslinking modules. Sterilization of Hybprinter is maintained by a HEPA filter, and the pre-polymer solution vat is sterilized with 70% ethanol followed by thorough rinsing with PBS before fabrication. To fabricate scaffold component, MME module uses filament of PCL as raw material to melt and deposit in a predefined trajectory and in a layer-by-layer fashion. The thermoplastic material re-solidifies quickly as extruded from the nozzle. The solidification is facilitated via blowing air by cooling fans. The material composition, scaffold strut size, scaffold porosity and pore size can be readily tailored by the system. For instance, the PCL filaments were molten in elevated temperature (˜140° C.), extruded as tiny struts of 350 μm and laid down in 0/90° patterns.

To form hydrogel components of hybrid constructs, a photocrosslinking mechanism such as DLP-SLA module is employed to gel a photocrosslinkable pre-polymer solution. In one embodiment, a visible light DLP is used as a safe light source for cells encapsulated in hydrogel. DLP exposes lights on the target area of solution vat based on cross section images of the hydrogel component. In this study, we utilized PEGDA for bioprinting of hydrogel component. According to the current invention, the photo-polymerizing light source is configured to project wavelengths in a range of UV to visible to gel the prepolymer coating according to the thermoset pattern. In one aspect, an exposure time of the photo-polymerizing light source is in a range of 0.5 second to 5 minutes.

In Hybprinter, as shown schematically in FIG. 1A, the process of forming hybrid constructs begins with deposition of molten thermoplastic material on the build platform at the scaffold region of the construct cross section. Then, the build platform immerses deep into the pre-polymer solution and returns upward to the level that secures one-layer thick solution on top. High intensity visible light is exposed for certain amount of time on the regions that need to be gelled into a thermoset plastic. Depending on the materials and applications different layer thickness can be used for MME and the photocrosslinking mechanism such as DLP-SLA modules. For instance, 300 and 100 μm layer thicknesses have been used for PCL scaffold and PEGDA hydrogel components, respectively. Thus, each layer of hybrid construct that was equal to 300 μm, has one layer of scaffold struts and 3 layers of hydrogel. The process repeats to complete the whole hybrid construct. The flowchart of the process is shown in FIG. 1B.

According to one aspect of the invention, the thermoplastic structure has a material that includes poly-(ε-caprolactone) (PCL), ABS (Acrylonitrile-Butadiene-Styrene), PLA (Polylactic acid), PLLA (poly-l-lactide acid), PGA (polyglycolide), PLGA ((poly(lactic-co-glycolic acid)), PolyEtherEtherKetone (PEEK), polyaryletherketone (PAEK), Polyetherketoneketone (PEKK), Thermoplastic polyurethane (TPU), Thermoplastic elastomers (TPE), High Impact Polystyrene (HIPS), Thermoplastic Copolyester (TPC), Poly(vinyl alcohol) (PVA), Polyamide (PA), Polycarbonate (PC), Wax, Polypropylene (PP), Poly(methyl methacrylate) (PMMA) electrical conductive PLA, carbon fiber filled thermoplastics, magnetic nanoparticle filled thermoplastics, or ferromagnetic nanoparticle filled thermoplastics.

In another aspect of the invention, the thermoset structure has material that includes acrylate-based, diacrylate-based, methacrylate-based, epoxy-based, silicone-based, poly-ethylene glycol diacrylate (PEGDA)-based, hyaluronic acid-based, and chitosan-based.

In a further aspect of the invention, the thermoset structure has a single layer thickness in a range of 5-300 micrometers. In one aspect of the invention, the thermoplastic structure has a single strut thickness in a range of 40-500 micrometers.

In another aspect of the invention, the thermoplastic or the thermoset includes an electrically conductive component (see FIG. 2G and FIG. 2H), where the electrically conductive component includes connections, wires, or antennas, where the electrically conductive component is embedded within thermoset or thermoplastic structures. For instance, the electrically conductive thermoplastic material can form conductive wires with a thermoplastic isolating shell surrounding it. In another example, the electrically conductive thermoset material can form conductive wires with a thermoset isolating shell surrounding it.

In another aspect of the invention, the thermoplastic or the thermoset includes a magnetic component such as magnetic/Ferrite nanoparticles suspended with prepolymer or mixed with thermoplastic material (see FIG. 2G).

According to the current invention, the preparation of input data to Hybprinter begins by generating a 3D assembly CAD model containing the rigid scaffold and hydrogel components. Then, each component is exported as STL format. In one embodiment, a G-code is generated to form scaffold component based on its porosity, strut size and layer thickness. The G-code of each scaffold layer is stored as a separate file. Also, a batch of cross section images of the hydrogel component is created as Scalable Vector Graphics (SVG) format, which are then converted to separate Portable Network Graphics (PNG) files. All the prepared data files are used as inputs in the machine operating software which has been built up on a LabView platform.

Hybprinter has a third syringe-based deposition module (SDM) that can be utilized to add a thermosensitive or chemically crosslinked hydrogels like collagen into the pores of the scaffold component, where the chemically crosslinked hydrogel can include fibrinogen, collagen, alginate, or chitosan, for example (see FIG. 1A).

According to another aspect, the invention further includes a suction mechanism configured to remove excess prepolymer material before deposition of the next thermoplastic material.

The control software prepares the raw data for conducting fabrication of each layer by the associated hardware module. The software also runs each module in a sequence which is required to build up the construct including moving nozzles in the trajectories, depositing/dispensing material, projecting lights onto photopolymer for certain time and adjusting the platform height for each process. According to one embodiment, the current control software is developed under NI Labview to facilitate any required modification for our research applications. One representative commander for one run is listed below:

Pseudo code
i = 0
Do
Run the sliced g code file (i + 1)
Move the nozzle and merge the stage to liquid
Run DLP images from (n * i + 1) to (n * i + 3)
Move the nozzle and stage back to the location before DLP
i++
Loop

According to other embodiments of the invention, the system can form structures composed of the following materials and their combinations:
Polymer (such as polycaprolactone, ABS, PLLA)
Ceramic (such as tri-calcium phosphate nanoparticles slurry)
Metal (such as gold or silver nanoparticles slurry)
Composite (such as either two or three combinations of Polymer, Ceramic, Metal)
Hydrogel (such as chitosan-based and polyethylene glycol)
Cells
Biochemical signals, including Growth Factors/Small Molecules/pharmaceutical drugs

It is understood that the term “a conduit shape structure” covers vasculature-like complexity structures such as bifurcating or manifold channels. Further, use of the term “a concentric shell around said thermoset conduit shape structure” applies to interfaces and to connect as shown in FIG. 6 and FIG. 7. In further embodiments, it may not be necessary for the conduit structure to be present in the other parts of the device besides the interfacing connection.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

This application claims priority from U.S. Provisional Patent Application 62/212,988 filed Sep. 1, 2015, which is incorporated herein by reference in its entirety.

What is claimed:

1) A simultaneous thermoplastic and thermoset deposition system comprising:
a) a substrate holder;
b) a thermoplastic molten-material extruder;
c) photo-polymerizing light source;
d) a prepolymer vat; and
e) a controller, wherein said controller controls said thermoplastic extruder to deposit a thermoplastic layer according to a thermoplastic pattern on said substrate holder, wherein said controller controls said substrate holder to immerse said thermoplastic layer in said prepolymer vat for coating said thermoplastic layer with a coating of said prepolymer solution, wherein said controller controls said substrate holder to position said prepolymer coated thermoplastic layer for exposure to said photo-polymerizing light source, wherein said controller controls said photo-polymerizing light source to cure said prepolymer coating according to a thermoset pattern on said thermoplastic layer, wherein said controller iteratively controls said substrate holder, said thermoplastic molten-material extruder, and said photo-polymerizing light source to form a thermoset structure that is integrated to a thermoplastic structure.

2) The simultaneous thermoset and thermoplastic deposition device of claim 1, wherein said thermoplastic structure comprises material selected from the group consisting of poly-(ε-caprolactone) (PCL), ABS, PLA, PLLA, PGA, PLGA, PEEK, PAEK, PEKK, polystyrene, TPU, TPE, HIPS, TPC, PVA, PA, PC, Wax, PP, PETT, PMMA, electrical conductive PLA, carbon fiber filled thermoplastics, magnetic nanoparticle filled thermoplastics, and ferromagnetic nanoparticle filled thermoplastics, or any combination thereof.

3) The simultaneous thermoset and thermoplastic deposition system of claim 1, wherein said thermoset structure comprises material selected from the group consisting of acrylate-based, diacrylate-based, methacrylate-based, epoxy-based, silicone-based, poly-ethylene glycol diacrylate (PEGDA)-based, hyaluronic acid-based, and chitosan-based, or any combination thereof.

4) The simultaneous thermoset and thermoplastic deposition system of claim 1, wherein said prepolymer vat comprises material selected from the group consisting of living cells, growth factors, and pharmaceutical drugs.

5) The simultaneous thermoset and thermoplastic deposition system of claim 1, wherein said photo-polymerizing light source is configured to project wavelengths in a range of UV to visible to gel said prepolymer coating according to said thermoset pattern.

6) The simultaneous thermoset and thermoplastic deposition system of claim 5, wherein an exposure time of said photo-polymerizing light source is in a range of 0.5 second to 5 minutes.

7) The simultaneous thermoset and thermoplastic deposition system of claim 1, wherein said thermoset structure comprises a single layer thickness in a range of 5-300 micrometers.

8) The simultaneous thermoset and thermoplastic deposition system of claim 1, wherein said thermoplastic structure comprises a single strut thickness in a range of 40-500 micrometers.

9) The simultaneous thermoset and thermoplastic deposition system of claim 1, wherein said thermoset component comprises a conduit shape structure or a solid core structure.

10) The simultaneous thermoset and thermoplastic deposition system of claim 9, wherein said thermoplastic structure comprises a concentric shell around said thermoset conduit shape structure or said solid core structure.

11) The simultaneous thermoset and thermoplastic deposition system of claim 1 further comprises a cooling system using air blowing mechanism, wherein said cooling system cools said extruded thermoplastic layer.

12) The simultaneous thermoset and thermoplastic deposition system of claim 1 further comprises a syringe-based deposition module (SDM) disposed to add a thermosensitive hydrogel or chemically crosslinked hydrogel into pores of said thermoplastic.

13) The simultaneous thermoset and thermoplastic deposition system of claim 1, wherein said thermoplastic or said thermoset comprises an electrically conductive component, wherein said electrically conductive component comprises connections, wires, or antennas, wherein said electrically conductive component is embedded within thermoset or thermoplastic structures.
